(19) United States
(12) Patent Application Publication
(10) Pub. No.: US 2025/0189316 A1
(43) Pub. Date: Jun. 12, 2025

(54) HOSTING OF AN INDIVIDUAL

(71) Applicant: KONE CORPORATION, Helsinki (FI)

(72) Inventors: Mika Belov, Helsinki (FI); Timo Saarnio, Helsinki (FI); Emilia Anttila, Helsinki (FI); Juhani Virta, Helsinki (FI); Anna Klemettilä-Sorri, Helsinki (FI); Mikko Aarras, Helsinki (FI); Rami Annala, Helsinki (FI)

(73) Assignee: KONE CORPORATION, Helsinki (FI)

(21) Appl. No.: 19/062,445

(22) Filed: Feb. 25, 2025

Related U.S. Application Data
(63) Continuation of application No. PCT/FI2022/050608, filed on Sep. 9, 2022.

(51) Int. Cl. G01C 21/20; B66B 3/00; G06V 20/52; G06V 40/16

(52) U.S. Cl. CPC G01C 21/206; B66B 3/006; G06V 20/52; G06V 40/172

(57) ABSTRACT

A method for hosting an individual on a journey utilizing at least one individual usable system operative in a building is provided. The method comprises: determining a user experience of the individual with respect to the at least one individual usable system; determining a location of the individual in the building; and generating at least one control signal to an output device residing in a location corresponding to the location of the individual during the journey causing an output of data to the individual, the data for outputting is selected in accordance with the user experience of the at least one individual usable system operative in the building. The invention also relates to a control system and to a computer program.

### TECHNICAL FIELD

The invention concerns in general the technical field of elevator systems. More particularly, the invention concerns a hosting of an individual in a building equipped with respect to the elevator system.

### BACKGROUND

The existing technologies enable a follow-up of individuals in a space, such as in a building, by utilizing various types of events recordable from the individuals roaming in the space. Such technologies may be based on a positioning of individuals with applicable positioning technology and/or monitoring technology.

On the other hand, buildings are becoming larger and larger all the time and the complexity of the buildings as well as the systems, like elevator systems, are increasing. For example, the user interfaces of the elevator systems are varied and allow a wider range of options to provide calls to the elevator systems. Moreover, in a case of large and tall buildings the elevator system may be established with so-called shuttle elevators and local elevators.

The increase in complexity of the various entities cause challenges for individuals to utilize the systems available in some space. This is due to that the individuals have various experience in the space as well as have varied capabilities to adopt the introduced technologies.

Therefore, there is a need to introduce approaches mitigating the challenges the technology is causing to individuals.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a control system, and a computer program for hosting an individual in a building.

The objects of the invention are reached by a method, a control system, and a computer program as defined by the respective independent claims.

According to a first aspect, a method for hosting an individual on a journey utilizing at least one individual usable system operative in a building is provided, the method, performed by a control system, comprises:
determining, on a basis of data received in relation to an individual, a user experience of the individual with respect to the at least one individual usable system operative in the building,
determining a location of the individual in the building during the journey,
generating at least one control signal to an output device residing in a location corresponding to the location of the individual during the journey, the generating of the at least one control signal causing an output of data to the individual, the data for outputting is selected in accordance with the user experience of the at least one individual usable system operative in the building.

The method may further comprise, for determining the user experience of the individual, a step of:
identifying the individual.

For example, data for identifying the individual may be received from a monitoring system configured to receive data indicative of an identity of the individual. The data may be received from at least one of the following: a terminal device of the individual, a reader device, an automatic identification system of an individual.

Still further, the user experience may be determined based on at least one of: a number of prior visits of the individual in the building, experience of a use of at least one system corresponding to the at least one individual usable system operative in the building.

The data for outputting may be selected from a data library defined based the user experience of the at least one individual usable system. For example, the data may be selected from the data library for outputting based on at least one of: the location of the individual, a location of the output device, an identifier of the output device.

The at least one individual usable system may be at least one of the following: an elevator system, an escalator, a moving walkway, an automatic door, an access gate, a smart building interface.

According to a second aspect, a control system for hosting an individual on a journey utilizing at least one individual usable system operative in a building, the control system is configured to:
determine, on a basis of data received in relation to an individual, a user experience of the individual with respect to the at least one individual usable system operative in the building,
determine a location of the individual in the building during the journey,
generate at least one control signal to an output device residing in a location corresponding to the location of the individual during the journey, the generating of the at least one control signal causing an output of data to the individual, the data for outputting is selected in accordance with the user experience of the at least one individual usable system operative in the building.

The control system for determining the user experience of the individual may further be configured to:
identify the individual.

For example, the control system may be configured to receive data for identifying the individual from a monitoring system configured to receive data indicative of an identity of the individual. The control system may be configured to receive the data from at least one of the following: a terminal device of the individual, a reader device, an automatic identification system of an individual.

Still further, the control system may be configured to determine the user experience based on at least one of: a number of prior visits of the individual in the building, experience of a use of at least one system corresponding to the at least one individual usable system operative in the building.

The control system may also be configured to select the data for outputting from a data library defined based the user experience of the at least one individual usable system. The control system may be configured to select the data from the data library for outputting based on at least one of: the location of the individual, a location of the output device, an identifier of the output device.

The control system may e.g. be arranged to host the individual on a journey utilizing at least one individual usable system being at least one of the following: an elevator system, an escalator, a moving walkway, an automatic door, an access gate, a smart building interface.

According to a third aspect, a computer program is provided, the computer program comprising instructions to cause a control system of a measurement system according to the second aspect as defined above to execute the steps of the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a system according to an example.

FIG. 2 illustrates schematically another aspect of a system according to an example.

FIG. 3 illustrates schematically a method according to an example.

FIG. 4 illustrates schematically a way of hosting an individual according to an example.

FIG. 5 illustrates schematically a control system according to an example.

### DESCRIPTION OF THE EXEMPLIFYING EMBODIMENTS

The specific examples provided in the description given below should not be construed as limiting the scope and/or the applicability of the appended claims.

Lists and groups of examples provided in the description given below are not exhaustive unless otherwise explicitly stated.

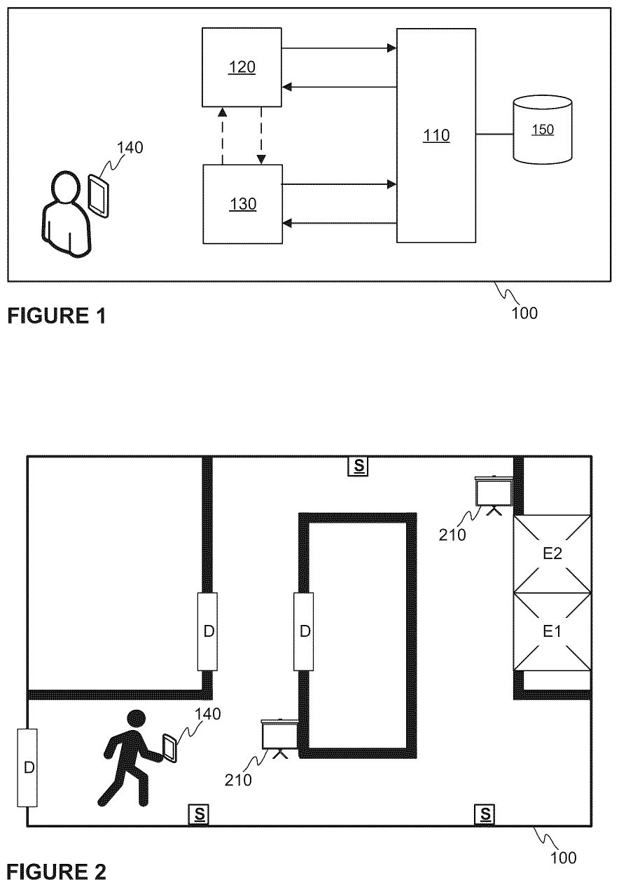

The present invention relates to hosting an individual in a building which may comprise a provision of a guidance to the individual in the building. The term building shall be understood in a broad manner comprising varied types of houses but also ships and any other structures into which the present invention may be implemented to. FIG. 1 illustrates schematically an example of an environment the present invention may be implemented to. The building is denoted with a reference 100 in FIG. 1. The building may be equipped with a number of individual usable systems 120, such as an elevator system, an escalator, a moving walkway, an automatic door, an access gate, a smart building interface, which are arranged to serve individuals in the building 100 in a manner dedicated to the system in question. The individual usable system(s) may also comprise an information system as a sub-system wherein the information system comprises one or more output devices, such as displays arranged in the building 100. The locations of the displays may be selected e.g. in accordance with traffic flows of individuals in the building 100. It is clear that at least one display may be positioned in a hall where individuals enter the elevator cars of the elevators. For sake of clarity it is worthwhile to add that the individual usable system 120 corresponds to any system which is dedicated to serve the individual in the building 100 and an access to use the respective system(s) 120 is provided and allowed to the individuals.

In addition to the number of individual usable systems 120 the building may be equipped with other systems which are not accessible to the individuals. An example of such a system may be a monitoring system 130 which is configured to generate data indicative on events occurring in the building 100. For example, the monitoring system 130 may provide tools for generating data indicative of an identity of the individual and/or of a location of the individual in the building 100 in an accuracy defined by the applied monitoring system 130. Hence, the monitoring system 130 may comprise an indoor positioning system by means of which it is possible to generate data indicative of the location of the individual.

The indoor positioning system may be arranged to monitor a location of a device, such as a mobile terminal 140, a tag, or any similar, carried by the individual in question. The respective device may e.g. be communicatively connected to one or more base stations of the indoor positioning system during a journey in the building 100 wherein the connection generates data enabling the positioning of the individual. Alternatively or in addition, the positioning of the individual may be based on an interaction of the individual with access devices, such as doors, gates, and similar individual usable systems 120, in the building 100 e.g. with a personal identification device, such as a tag, a magnetic card or similar which allows identification of the individual based on the data transferred during the interaction. Still further, the monitoring system 130 may comprise sensors, such as cameras and similar, configured to generate data by means of which the individual may be identified and monitored in the building 100, i.e. the monitoring system 130 may comprise an automatic identification system of individuals entering the building. The identification may e.g. be based on facial recognition methods and similar.

The systems arranged in the building 100, such as the number of individual usable systems 120 and the monitoring system 130 may be controlled with a control system 110. The control system 110 may be common to a plurality of the systems in the building 100 or the controlling may be performed by arranging dedicated control systems 110 for each system and selecting one as a master control system into which the other control systems 110 are communicatively connected. Moreover, even if the control system 110 is schematically illustrated as a separate entity in FIG. 1, it may also be part of one of the systems 120, 130 arranged in the building 100 wherein it is arranged to perform the method according to the invention as is described in the forthcoming description. An example of such a control system may e.g. be an elevator controller.

Still further, the control system 110 may be provided with an access to data stored in data storage 150. The data may be stored in a database hosted by the data storage 150. The data stored therein may comprise various type of data related to individuals visiting the building 100. In accordance with the present invention the data may be indicative on a user experience at least with respect to the number of individual usable systems 120, such as the elevator system. The data indicative of the user experience may be established based on various pieces of information. For example, the pieces of information may comprise data indicative of at least one of the following: a visiting history of an individual in the building 100, an operation history of the one or more individual usable systems 120 by an individual either in the building in question or in another building having the same type of individual usable systems 120, biometric data of an individual (e.g. age, . . . ), and so on.

For providing further aspects regarding the implementation of the present invention according to an embodiment it is hereby referred to FIG. 2 illustrating an exemplified floor layout. For describing at least some aspects of the present invention it is hereby assumed that the individual usable system 120 corresponds to an elevator system arranged in the building 100. For example, the elevator system may comprise two elevators denoted with E1 and E2. Moreover, the building 100 may be provided with a monitoring system 130 comprising a number of sensors S which in the non-limiting example embodiment of FIG. 2 are arranged to communicate with the terminal device 140 of the individual visiting the building 100. In other words, when the individual accesses the building 100 and the floor in question e.g. through an entrance door (doors denoted with D in FIG. 2), the terminal device 140 may establish a communication connection e.g. with a short-range communication technology to a sensor S residing close to the entrance door D. When the individual roams in the floor new communication connections may be established with other sensors S arranged in various locations at the floor. In other words, it may be arranged that the monitoring system 130, especially the control system 110 of the monitoring system 130, may maintain information on the data connections of the sensors S and allow only one connection at a time. In this manner, it is possible to monitor the location of the individual, and especially her/his terminal device 140, at the floor in question. Moreover, the floor according to exemplified embodiment may be equipped with a number of output devices 210, such as display devices, which may be controlled with the control system 110 and be e.g. a part of the elevator system 110, or a building management system in some implementations. The selection of an output device 210 for outputting information may be selected in relation to a location of the individual at the floor.

Regarding the terminal device 140 of the individual it may be equipped with an application software enabling a communicative connection with the number of sensors S, but it may also be configured to communicate with the control system 110 e.g. through the number of sensors S or over another communication connection arranged between the terminal device 140 and the control system 110. For example, the individual may provide an input with respect to a service of the elevator system with the application software.

For sake of completeness the input with respect to service of the elevator system may also be provided through a specific input device arranged in a number of locations at the floor. For example, such an input device may be arranged at the entrance door D and/or at the hall the access to the elevators E1, E2 occurs. The input of information, such as any requests, through the input device may require authentication of the individual at least in some embodiments.

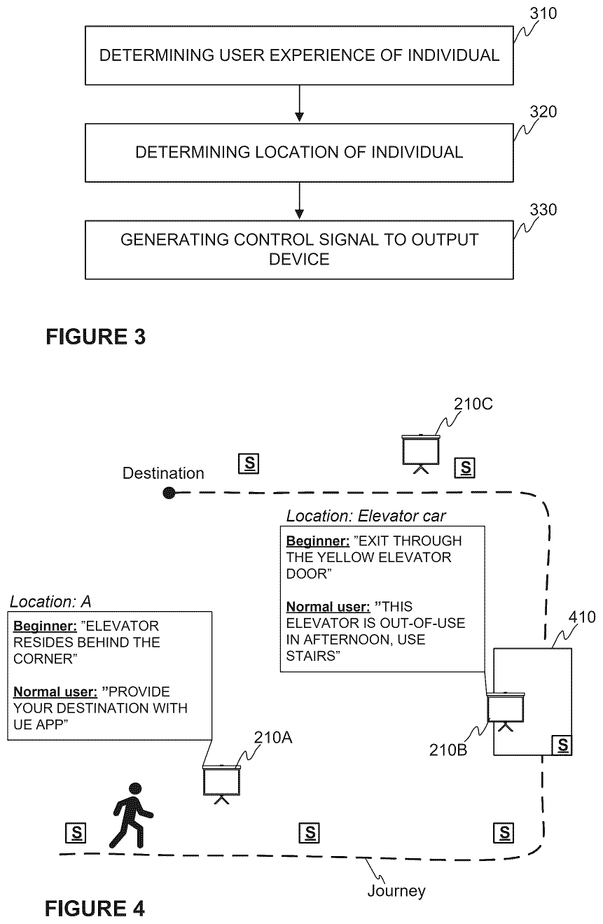

Next, at least some aspects of the present invention are described by referring to FIG. 3 schematically illustrating a method according to an example in which it is also assumed that the individual usable system 120 is an elevator system. The method is for hosting an individual on a journey in the building which may correspond to that the individual is provided guidance during the journey in which an elevator service is required.

In step 310 user experience with respect to the individual usable system 120, i.e. an elevator system 120 in the present non-limiting example, utilizable during the journey is determined 310. The determination 310 may be performed based on data available in the data storage 150 with respect to the individual. In order to access such data the individual is advantageously identified at some instant of time the individual resides in the building 110, or in a location based on which it may be assumed that she/he enters the building. The identification may be performed in any known manner e.g. by using the monitoring system 130 implemented in the building 100. For example, the terminal device 140 of the individual may be communicatively connected to at least one sensor S, or to a base station configured to provide a coverage of wireless local area network at the location, and the terminal device 140 may transfer piece of data identifying the individual at a required accuracy. The accuracy may e.g. refer to a determination if the individual has visited the building earlier or not. Alternatively or in addition, a prior experience of using an elevator system corresponding to one residing in the building 100 may be applied to if such information is stored in the data storage. This may be performed by delivering the piece of data identifying the individual to the control system 110 which may be configured to set up an inquiry toward the data storage to determine a level of user experience with respect to the elevator system. The piece of data delivered for the identification of the individual may be stored in a memory of the terminal device 140 and obtained automatically therefrom e.g. by the application program for delivering it to the control system 110. Naturally, it is possible to arrange that the piece of data identifying the individual may be input by the user through a user interface of the terminal device 140. Still further, the data identifying the individual may be obtained in any other manner as already discussed, such as by using an interface communicatively connected to the control system 110 in a manner required by the interface. The interface may herein refer to any type of reader device with which the individual may interact with any device or similar, such as a tag or a magnetic card, in order to transfer the piece of data. Alternatively or in addition, the individual may provide the data for identification by means of her/his terminal device 140 or the individual may be identified with an automatic identification system e.g. as a sub-system of the monitoring system 130. The approaches described herein may enable the control system 110 to generate a control signal to the monitoring system 130 to cause a follow up of the individual in the building 100 with a sensor system implemented in the building, for instance. Hence, the monitoring system 130 may be arranged to be capable of following the device carried by the individual with further reader, or sensor, devices, for example. Alternatively, the monitoring system 130 may be equipped with image capturing device and an image is captured on the individual at the reader device and by using sophisticated recognition algorithms a roaming of the individual may be followed with an image capturing device network implemented at the floor through applying the recognition algorithms. The control system 110 may associate the data received from the reader device with data derivable from the recognition algorithms for further use.

In accordance with an example it may be assumed that the individual is always performing a journey in the building 100 requiring service from the elevator system. This may be the case if the entrance floor is only for accessing the building 100 and any destinations, such as apartments, office premises, and similar reside at other floors into which an access may be performed by using the elevator system. In accordance with another example the individual may indicate in some manner the need for the elevator service during the visit in the building 100 e.g. by indicating this through her/his terminal device 140 or an interface residing on the way of the journey of the individual in the building 100. The indication may e.g. be a destination address of the visit, such as location details of the destination or a destination floor or anything similar by means of which it is possible to determine that the elevator service is required in the journey in the building 100. The information indicative of the destination may be provided in the same context as the identification data is provided to. Depending on the implementation of the present invention the information defining the destination of the individual may cause a determination of the path of the journey the individual follows, or shall follow, in the building 100. The same kind of approach may be taken with respect to other types of individual usable systems 120 available in the building 100 in question.

As mentioned, the data received in relation to the individual allows the control system 110 to perform the step of determining 310, on a basis of data received in relation to an individual, a user experience of the individual, with respect to the individual usable systems 120, such as the elevator system. As already hinted in the foregoing description the accuracy of the information may be at a level of if the individual has visited in the building earlier or not, or it may be more sophisticated than that. For example, the user experience may be defined at a plurality of levels, such as ‘beginners’, ‘normal users’, and ‘expert users’ and each of these levels may have requirements in order to that an individual may be classified to one of these classes. For example, the individuals of whom there is not stored any data entry in the data storage 150 are always considered as beginners and remained there until they have visited the building and/or used the number of individual usable systems 120, such as the elevator system, X number of times. Correspondingly, the expert users may be those individuals who are defined to be allowed to perform at least some maintenance tasks to the respective individual usable systems 120 like the elevator system 120. Further, the normal users are something between these other two. As said, the classification in the described manner is a non-limiting example and other approaches for classification may be applied to. In other words, the data storage 150 may return data indicative of the user experience with respect to the individual usable systems 120 in question, such as the elevator system 120, in response to the inquiry. As derivable from the description so far, the user experience with respect to the system 120 may also be determined based on the experience with respect to the building 100.

The determination 310 of the user experience of the individual may cause the control system 110 to select a data library for outputting data in accordance with the user experience as is described in the forthcoming description. The data library e.g. defines pieces of information to be outputted to the individual through the output devices 210 wherein the pieces of information correspond to the level of the user experience in the selected data library.

Next, in step 320 the control system is configured to perform a determination 320 of a location of the individual in the building 100 during the journey. This refers to an approach in which the individual roams in the building 100 along the path of the journey which may be selected by the individual or the individual follows a pre-planned path of the journey which may e.g. be provided to the individual over the terminal device 140 or by using a signalization devices arranged in the building 100. The determination of the location may be performed by using any of the known mechanism e.g. provided by the monitoring system 130 as discussed in the foregoing description. The location of the individual may be followed in a continuous manner or at intervals in time.

Next, the control system 110 is aware of the location of the individual, but it also is aware of locations of the output devices 210 at floors as well as the output devices of the elevator cars of the elevators E1, E2 and is communicatively connected to those and capable of causing an output of data in them. The control system 110 may be arranged to detect that the individual is at a predefined distance from an output device 210 on a basis of the location information. For example, the control system 110 may be arranged to compare a location of the individual with a location of the output device 210, such as a display device, and upon a detection that that distance is below a predefined limit, to generate an indication that the individual resides within an operational area of the output device 210 in question. The operational area herein refers to an approach that the individual may receive data output by the output device 210. For sake of clarity it is worthwhile to mention that a similar detection process may performed continuously when the individual is roaming at the location and upon a detection that the individual resides close to at least one output device 210 the respective output device 210 is identified by the control system 110.

Moreover, in response to the determination of the location of the individual the control system 110 may be configured to generate 330 at least one control signal to an output device 210 residing in a location corresponding to the location of the individual during the journey to output data with respect to the individual usable systems 120, such as the elevator system 120, to the individual wherein the data for outputting is selected in accordance with the user experience of the respective individual usable system 120. In other words, the control system 110 may be configured to derive data from the data library selected based on the user experience as described above and cause, with the control signal, outputting the data to the individual on the output device 210 corresponding to the location of the individual. For sake of completeness, it shall be mentioned that the location of the output device 210 and the location of the individual shall correspond to each other at a predefined accuracy, wherein the accuracy may e.g. be determined based on a distance the individual may utilize the information output with the output device 210, or any other criteria. The data selected for output may be defined in the data library on a basis of the output device 210, i.e. an identifier of the output device 210 is used to inquiry the data from the data library that is to be output. Alternatively, a location data of the individual, and/or the output device 210, may be used as a parameter to inquire the data to be output. In other words, the data stored in the data libraries has attributes based on which the selection of the data for outputting with the output device 210 in question may be performed. As a conclusion of the step 330 the control system 110 causes the output of the selected data by generating 330 the control signal which may also carry the data to be output or indicate data storage or similar from which the data may be obtained by the respective output device 210 or from which it is delivered to the output device 210.

In the described manner it is possible to host the individual during the journey in the building 100 and provide data to help the individual to cope with in the building 100 wherein the data is selected based on the user experience of the individual.

FIG. 4 schematically illustrates a way of hosting an individual in a building 100 during a journey according to an example. The individual usable system 120 in the non-limiting example of FIG. 4 is an elevator system. Further, in FIG. 4 it is shown data output to two individuals having different user experiences which may be determined e.g. in the described manner upon an entry to the building 100. The location of the individual may e.g. be monitored with the sensors S and the individual utilizes the elevator system in the journey which is marked with a dashed line in FIG. 4. An advantage of the present invention is to host the individual in the building 100 in accordance with the individual's user experience wherein the hosting relates to the utilization of the elevator system. In the non-limiting example of FIG. 4 the hosting is performed by controlling the number of output devices denoted as 210A, 210B, 210C in FIG. 4 to out the data obtained by the control system 110 on the basis of the user experience. The obtainment of data may comprise, but is not limited to, selecting a data library to be applied in accordance with the user experience and selecting therefrom the data to be output on a basis of a location of the individual. Now, the control systems 110 is aware of the individual's user experience as well as her/his location in an operational area of the output device 210A. In case the individual is detected to be a ‘beginner’ as the user experience, such that has not visited the building 100 before and/or not used an individual usable systems in question, such as an elevator system corresponding to the elevator system 120 in the building 100 in question or the elevator system 120 itself, the control system 110 causes an output of data informing the beginner individual on the location of the elevators E1, E2 with a message “Elevator resides behind the corner”. On the other hand, if the individual is classified as a normal user, the control system 110 may be configured to generate a message “Provide your destination with UE app” which refers to an application program executed by the terminal device 140 of the individual. Based on the received input by the individual, the control system 110 may e.g. generate an elevator call to the floor the individual resides. Correspondingly, when the user proceeds in her/his path, she/he enters the elevator car 410 at some point and an output device 210B residing in the elevator car 410 is used for providing further guidance to the individual in order to continue the hosting of the individual. In case of that the individual is a beginner the message may inform the door the individual shall select when exiting at the floor. Naturally, such instruction is applicable only if the elevator has two doors and both are opened at the floor in question. On the other hand, if the individual is a normal user, the message may e.g. contain information related to the maintenance of the elevator system and recommend the individual to use stairs. Since the individual knows the building 100, she/he is aware of the stairs and the message may have value for her/him. Furthermore, at the destination floor the individual may be provided with corresponding information defined by the user experience by using an output device 210C residing at the respective floor. In case of the example as shown in FIG. 4 the output devices 210A, 210B, 210C are display devices in order to show the messages, but the information may output in any other way, such as with audio messages.

As already mentioned, the present invention is not limited to any specific individual usable system 120 and at least the following systems may be considered as the individual usable systems 120: an elevator system, an escalator, a moving walkway, an automatic door, an access gate, a smart building interface. In some implementations of the present invention, the user experience may be determined 310 based on the individual's experience with respect to a plurality of the individual usable systems 120, i.e. an aggregate value representing the user experience may be generated. Further, the data generated for outputting may be such that it relates to an individual usable system 120 detected to be close the individual at an instant of time the data is output.

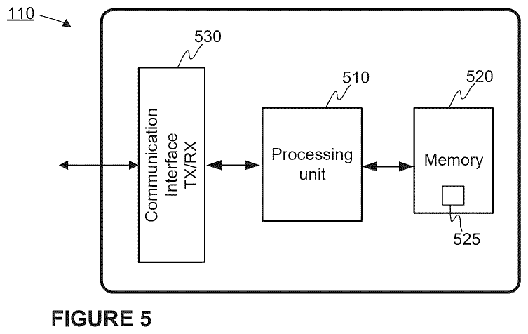

As already mentioned, the aspects of the present invention described herein are mainly done by referring to an implementation in which the controlling entity is a dedicated control system 110 as shown in FIG. 5. The functionality of the control system 110 may also be integrated to another computing device. An example of an apparatus configurable to implement the operation of the computing device, and, thus, the control system 110, is schematically illustrated in FIG. 5. In other words, the control system 110 may be configured to perform the method according to the invention as described with the examples in the foregoing description. In other words, the apparatus of FIG. 5 may be configured to perform a function to manage a hosting of an individual in her/his route. For sake of clarity, it is worthwhile to mention that the block diagram of FIG. 5 depicts some components of an entity that may be employed to implement a functionality of the apparatus.

The apparatus of FIG. 5 comprises a processor 510 and a memory 520. The memory 520 may store data, such as pieces of data as described, but also computer program code 525 causing the management of the hosting, and providing the guidance, in the described manner. The apparatus may further comprise a communication interface 530, such as a wireless communication interface or a communication interface for wired communication, or both to communicate with other entities as described. The communication interface 530 may thus comprise one or more modems, antennas, and any other hardware and software for enabling an execution of the communication e.g. under control of the processor 510. Furthermore, I/O (input/output) components may be arranged, together with the processor 510 and a portion of the computer program code 525, to provide a user interface for receiving input from a user, such as from a technician, and/or providing output to the user of the apparatus when necessary. In particular, the user I/O components may include user input means, such as one or more keys or buttons, a key-board, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 520 and at least a portion of the computer program code 525 stored therein may further be arranged, with the processor 510, to cause the apparatus to perform at least a portion of a method as is described herein. The processor 510 may be configured to read from and write to the memory 520. Although the processor 510 is depicted as a respective single component, it may be implemented as respective one or more separate processing components. Similarly, although the memory 520 is depicted as a respective single component, it may be implemented as respective one or more separate components, some, or all of which may be integrated/removable and/or may provide permanent/semi-permanent/dynamic/cached storage.

The computer program code 525 may comprise computer-executable instructions that implement functions that correspond to steps implemented in the method when loaded into the processor 510 of the respective control system 110. As an example, the computer program code 525 may include a computer program consisting of one or more sequences of one or more instructions. The processor 510 is able to load and execute the computer program by reading the one or more sequences of one or more instructions included therein from the memory 520. The one or more sequences of one or more instructions may be configured to, when executed by the processor 510, cause the apparatus to perform a method as described. Hence, the apparatus may comprise at least one processor 510 and at least one memory 520 including the computer program code 525 for one or more programs, the at least one memory 520 and the computer program code 525 configured to, with the at least one processor 510, cause the apparatus implementing the control system 110 to perform the method.

The computer program code 525 may be provided e.g. a computer program product comprising at least one computer-readable non-transitory medium having the computer program code 525 stored thereon, which computer program code 525, when executed by the processor 510, causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 525 may comprise a proprietary application, such as computer program code for causing an execution of the method in the manner as described in the description herein.

Any of the programmed functions mentioned may also be performed in firm-ware or hardware adapted to or programmed to perform the necessary tasks.

For sake of completeness it is worthwhile to mention that the entity configured to perform the method in the role of the control system 110 may also be implemented with a plurality of apparatuses, such as the one schematically illustrated in FIG. 5, as a distributed computing environment corresponding to a control system. For example, one of the apparatuses may be communicatively connected with the other apparatuses, and e.g. share the data of the method, to cause another apparatus to perform at least one other portion of the method. As a result, the method performed in the distributed computing environment generates the control signal indicative of the assignment of the responsibility as described. For example, some steps of the method may be shared between the control system 110, a controller of the individual usable system(s) 120, and a controller of the monitoring system 130, for example.

The advantage of the invention as described herein with the number of examples is that it enables an individual hosting of a person entering in the building with a need to reach a destination wherein the journey requires at least in part a utilization of one or more individual usable systems 120. This kind of approach may relieve stress of individuals visiting the building due to that the information provided to them is selected based on their previous experience with respect to the premises, such as the building and/or the individual usable system(s) 120, like the elevator, for instance.

The specific examples provided in the description given above should not be construed as limiting the applicability and/or the interpretation of the appended claims. Lists and groups of examples provided in the description given above are not exhaustive unless otherwise explicitly stated.

1. A method for hosting an individual on a journey utilizing at least one individual usable system operative in a building, the method, performed by a control system, comprises:
determining, on a basis of data received in relation to an individual, a user experience of the individual with respect to the at least one individual usable system operative in the building,
determining a location of the individual in the building during the journey,
generating at least one control signal to an output device residing in a location corresponding to the location of the individual during the journey, the generating of the at least one control signal causing an output of data to the individual, the data for outputting is selected in accordance with the user experience of the at least one individual usable system operative in the building.

2. The method according to claim 1, the method further comprising, for determining the user experience of the individual, a step of:
identifying the individual.

3. The method according to claim 2, wherein data for identifying the individual is received from a monitoring system configured to receive data indicative of an identity of the individual.

4. The method according to the claim 3, wherein the data is received from at least one of the following: a terminal device of the individual, a reader device, an automatic identification system of an individual.

5. The method according to claim 1,
wherein the user experience is determined based on at least one of: a number of prior visits of the individual in the building, experience of a use of at least one system corresponding to the at least one individual usable system operative in the building.

6. The method according to claim 1,
wherein the data for outputting is selected from a data library defined based the user experience of the at least one individual usable system.

7. The method according to claim 6, wherein the data is selected from the data library for outputting based on at least one of: the location of the individual, a location of the output device, an identifier of the output device.

8. The method according to claim 1,
wherein the at least one individual usable system is at least one of the following: an elevator system, an escalator, a moving walkway, an automatic door, an access gate, a smart building interface.

9. A control system for hosting an individual on a journey utilizing at least one individual usable system operative in a building, the control system is configured to:
determine, on a basis of data received in relation to an individual, a user experience of the individual with respect to the at least one individual usable system operative in the building,
determine a location of the individual in the building during the journey,
generate at least one control signal to an output device residing in a location corresponding to the location of the individual during the journey, the generating of the at least one control signal causing an output of data to the individual, the data for outputting is selected in accordance with the user experience of the at least one individual usable system operative in the building.

10. The control system according to claim 9, the control system for determining the user experience of the individual is further configured to:
identify the individual.

11. The control system according to claim 10, wherein the control system is configured to receive data for identifying the individual from a monitoring system configured to receive data indicative of an identity of the individual.

12. The control system according to the claim 11, wherein the control system is configured to receive the data from at least one of the following: a terminal device of the individual, a reader device, an automatic identification system of an individual.

13. The control system according to claim 9, wherein the control system is configured to determine the user experience based on at least one of: a number of prior visits of the individual in the building, experience of a use of at least one system corresponding to the at least one individual usable system operative in the building.

14. The control system according to claim 9, wherein the control system is configured to select the data for outputting from a data library defined based the user experience of the at least one individual usable system.

15. The control system according to claim 14, wherein the control system is configured to select the data from the data library for outputting based on at least one of: the location of the individual, a location of the output device, an identifier of the output device.

16. The control system according to claim 9, wherein the control system is arranged to host the individual on a journey utilizing at least one individual usable system being at least one of the following:
an elevator system, an escalator, a moving walkway, an automatic door, an access gate, a smart building interface.

17. A non-transitory computer readable medium storing a computer program comprising instructions to cause a control system of a measurement system according to claim 9.

18. The method according to claim 2, wherein the user experience is determined based on at least one of: a number of prior visits of the individual in the building, experience of a use of at least one system corresponding to the at least one individual usable system operative in the building.

19. The method according to claim 3, wherein the user experience is determined based on at least one of: a number of prior visits of the individual in the building, experience of a use of at least one system corresponding to the at least one individual usable system operative in the building.

20. The method according to claim 4, wherein the user experience is determined based on at least one of: a number of prior visits of the individual in the building, experience of a use of at least one system corresponding to the at least one individual usable system operative in the building.
